(19) United States
(12) Patent Application Publication
(10) Pub. No.: US 2025/0082130 A1
(43) Pub. Date: Mar. 13, 2025

(54) SUPPORT WITH WIND PROTECTION AND HEAT RECOVERY FOR BURNERS

(71) Applicant: Juan TEN BOQUERA, Piles (ES)

(72) Inventor: Juan TEN BOQUERA, Piles (ES)

(21) Appl. No.: 18/728,459

(22) PCT Filed: Jan. 23, 2023
(86) PCT No.: PCT/ES2023/070032

§ 371 Date: Jul. 12, 2024

(30) Foreign Application Priority Data
Jan. 25, 2022 (ES) U202230111

(51) Int. Cl. A47J 36/34; A47J 36/36

(52) U.S. Cl. CPC A47J 36/34; A47J 36/36

(57) ABSTRACT

A tripod for gas burners, having the capability for levelling the legs thereof, as well as the capability for holding a conventional burner, also including an opening for gas hoses that extend to a tank and a base that reflects the infrared radiation from the burner, thereby improving energy efficiency. Versions have been envisaged that include an adjustable ventilator which facilitates combustion.

### TECHNICAL FIELD

The present invention falls within the industrial sector dedicated to the supply of articles for the hotel and catering industry.

### BACKGROUND

Different gas burners used for the preparation of meals, both small and large, are well known. These burners, also known as gas paella burners, are portable and distribute their flame in at least one circumference, having the corresponding regulation valves and tubes or hoses connected to a gas tank. In many occasions their use is done outdoors, with the inconvenient of the wind, which supposes an irregular flame distribution, even that this can be extinguished in its totality or by sectors.

In order to place these burners, the use of different tripods is usually used, with a concave element at the upper end of their legs to support the burner legs, as stated in document ES0174796U (Jan. 5, 1972) of the holder Francisco Beltrán Segarra, this type of supports can pose a risk to the stability of the burner and the container with which it is cooking in the event of any accidental blow to any part of the whole, especially important when it is a gastronomic event of large capacity.

There are also known different windbreaks also called windbreaks or windshields used for example in small stoves for activities such as camping, including some composed of rectangular metal plates that are suspended from hooks on the edge of the container.

These usually present problems for cleaning because either the burner is usually fixed to the windshield or in the case of the plates they move when the wind is intense; neither their design allows an optimization of the energy source used.

There are no known burner supports that solve these problems as advantageously as the recommended solution.

### SUMMARY

The support with anti-wind and heat recovery for burners, presents means to safely house a gas burner of the so-called transportable by having a flat base of circular geometry from which rises inscribed a triangle inside which are retained the legs of the gas burner. This triangular configuration allows to accommodate different sizes of burners, on this flat base has a windproof element formed by a cylinder, which presents in its perimeter of an opening whose size allows to accommodate the connection hose to the gas tank and its corresponding connection valve to it. This flat base, in addition to protecting from the wind, has the technical effect of recovering the heat emitted by the burner due to the reflection of infrared radiation, which improves energy efficiency.

There are versions in which the diameter of the anti-wind element is larger than the base that supports it, for which it has at least three support elements as platens that start perpendicularly from the anti-wind element towards its center and whose length allows them to support on the base exceeding its perimeter. From the other side of the base described at least three guides preferably cylindrical, which act in cooperation with at least three legs of identical geometry and significantly larger size, so that they form a prismatic pair by sliding one inside the other. In one embodiment, the guides have a number of through holes that pass through the screws of the retaining element, defining fixed positions for the legs and therefore height to the floor of the base. The end of the legs presents means to regulate its length to level the set against the possible irregularities of the ground, these means consist of the cooperation of a pair of thread and screw, which is actuated by means of a crank, presents from the free end of the screw a portion of laminar material perpendicular to it in contact with the ground that defines a support.

Versions have been foreseen in which the windshield has at least one adjustable ventilator by means of an opening practiced in this one that cooperates with a sliding door proportional to this opening, this allows to provide more oxygen to the combustion at the same time that observes the correct operation of the burners when they are in operation.

The set can be disassembled, facilitating its transport and cleaning, preferably the base and the windproof element are made of aluminum for its excellent properties in the reflection of infrared radiation, representing an important energy saving and sustainable character.

### BRIEF DESCRIPTION OF THE DRAWINGS

For a better understanding of what is described in the present report, some drawings are included in which, by way of example, a list of the figures of the proposed invention is shown.

FIG. 1 shows a perspective view of the heat recovery wind shield for burners, showing the wind shield (1), the opening (2), the base (3) with the triangular support (4) for the burner, its legs (5), handle (6) and the supports (7) of the legs.

FIG. 2 shows an exploded side view, where it can be seen the windshield (1), the triangular support (4) of the burner, the guides (9) of the legs, as well as the retainers (8) of the legs.

FIG. 3 shows the adjustable ventilator (10) of the windshield in a closed configuration.

FIG. 4 shows the adjustable ventilator (10) of the windshield in an open configuration.

FIG. 5 shows an anti-wind element whose diameter is larger than the base of the support, the support elements (11) allow it to be placed on the base.

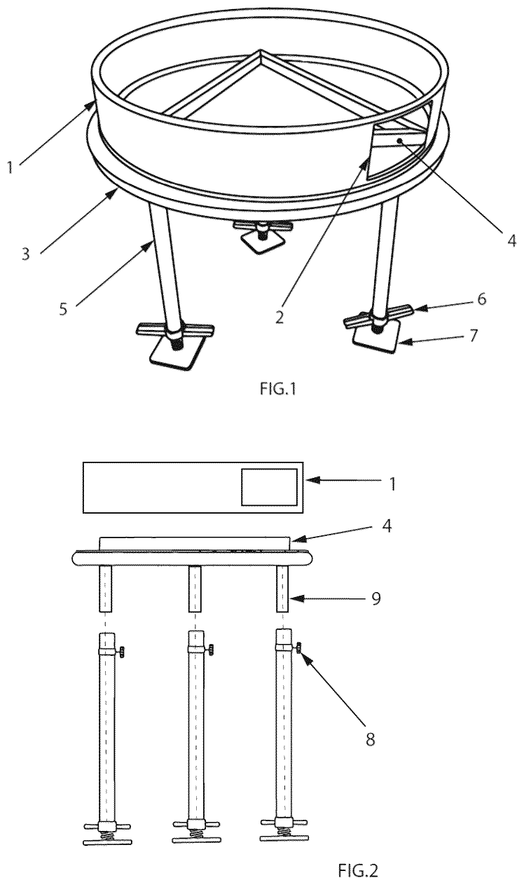

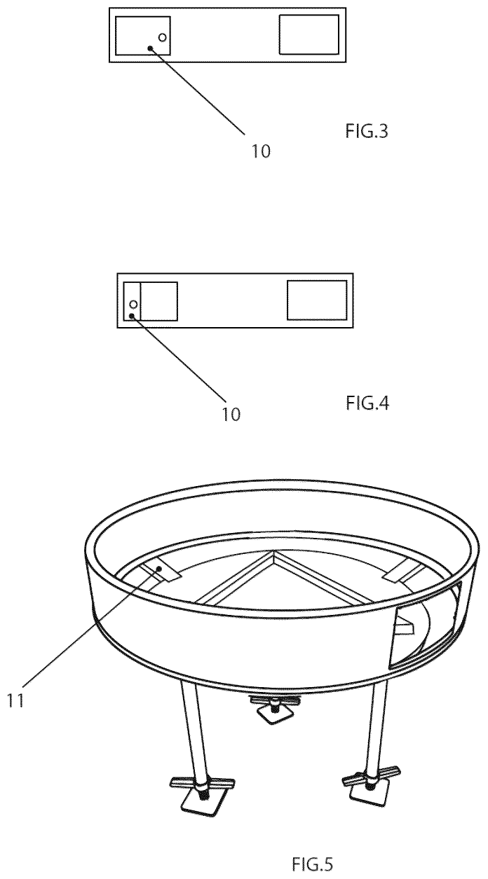

### DETAILED DESCRIPTION OF THE EMBODIMENTS

The materials used in its manufacture, as well as the methods of application and all the accessory details that may arise, provided that they do not affect its essentiality, are independent of the object of the invention and are cited as an example of a preferred embodiment.

The windproof support object of this preferred embodiment has means to safely house a so-called portable gas burner whose connection to the gas tank is made by means of a tube or hose, allowing to efficiently use this heat source and avoid the effect of the wind when used outdoors, For this purpose, it has a flat base (3) of circular geometry, from which emerges a triangular support (4) used to house the gas burner (not shown), on this base is placed the windshield (1) consisting of a cylindrical body with a diameter significantly smaller than the base, which has an opening (2) through which can be inserted the hose connection and valve to the gas tank (not shown). The lower face of the base in this mode of realization presents three guides (9) for the cylindrical section legs, which cooperate with three legs (5) in such a way as to constitute a sliding guide, the relative fixing between the two bodies is possible by means of a conventional joint by means of a clamping element (8) formed by a screw; the guides present a plurality of through holes that define with the clamping element some predefined positions.

In this version the windshield has an adjustable ventilator (10) formed by an opening in the windshield that cooperates with a sliding door proportional to said opening. It presents means for leveling the base by means of the cooperation of a pair thread and screw, which is actuated by means of a crank (6), presents from the free end of the screw of a portion of laminar material perpendicular to it in contact with the ground defining a support (7). The location of the leveling mechanism close to the floor allows its adjustment with the foot, of special importance in rectifications that are usually made when the cooking of the food has already started.

The base and the windshield are made of aluminum for its high reflection of infrared radiation, which optimizes the efficiency of the burner.

1-5. (canceled)

6. A support with windshield and heat recovery for burners, comprising: a cylindrical windshield with an opening for the exit of the hoses to the gas tank, placed on a flat base that reflects infrared radiation of a burner towards a cooking vessel, from which emerges a triangular support of the burner, from an opposite side of the base emerge at least three guides that cooperate with at least three legs of complementary geometry forming a sliding guide, from at least three clamping elements by a screw that fixes each guide to its corresponding leg, from at least one leveling element close to the floor formed by a screw and a nut with crank and from a support plate on its legs.

7. The support with windproof and heat recovery for burners according to claim 6, wherein its windproof and base are made of aluminum.

8. The support with windproof and heat recovery for burners according to claim 7, further comprising presenting the at least three guides of the legs of a plurality of through holes that, in cooperation of the clamping elements, define fixed positions.

9. The support with wind and heat recovery for burners according to claim 8, further comprising a ventilator that is adjustable by at least one opening, practiced in it that cooperates with a sliding door proportional to said opening.

10. The support with wind and heat recovery for burners according to claim 9, further comprising at least three support elements as platens that start perpendicularly from the wind element towards its center, and whose length exceeds the perimeter of the base when it is placed on the latter.
